(19) United States
(12) Patent Application Publication
(10) Pub. No.: US 2014/0128133 A1
(43) Pub. Date: May 8, 2014

(54) HARVESTER HAVING CHAFFER WITH TILTABLE SECTION

(71) Applicant: AGCO Corporation, Duluth, GA (US)

(72) Inventor: Bryan S. Claerhout, Hesston, KS (US)

(73) Assignee: AGCO Corporation, Duluth, GA (US)

(21) Appl. No.: 14/069,482

(22) Filed: Nov. 1, 2013

Related U.S. Application Data
(60) Provisional application No. 61/721,814, filed on Nov. 2, 2012.

(51) Int. Cl. A01F 12/44

(52) U.S. Cl. CPC A01F 12/44
USPC 460/101

(57) ABSTRACT

An adjustable chaffer assembly is operable to be mounted in a chaffer housing of a harvester. The adjustable chaffer assembly includes forward and aft chaffer sections. The forward chaffer section includes a forward frame assembly and adjustable forward louvers shiftably mounted on the forward frame assembly. The aft chaffer section includes an aft frame assembly and adjustable aft louvers shiftably mounted on the aft frame assembly. The aft chaffer section is shiftably mounted relative to the forward chaffer section and is shiftable between a parallel condition where the frame assemblies are substantially parallel with each other and an oblique condition where the frame assemblies define an oblique angle.

### CROSS REFERENCE TO RELATED APPLICATION

This application claims the benefit of U.S. Provisional Application No. 61/721,814, entitled HARVESTER HAVING CHAFFER WITH TILTABLE SECTION filed Nov. 2, 2012, which is hereby incorporated by reference in its entirety.

### BACKGROUND OF THE INVENTION

1. Field of Invention

This invention relates generally

2. Description of Related Art

Prior art grain harvesters have long used a chaffer to separate grain from material other than grain (MOG). Conventional chaffers have a frame that supports a series of spaced apart louvers. The louvers are positioned to allow grain to fall downwardly through the chaffer while allowing a flow of cleaning air to pass upwardly and rearwardly through the chaffer. The cleaning air flow tends to force MOG rearwardly and restricts MOG from falling through the chaffer.

While conventional chaffers have been used in harvesters for many years, such chaffers still have certain deficiencies. For example, the prior art chaffer designs allow grain to be transported rearwardly with MOG without falling through the chaffer. Grain that does not fall downwardly through the chaffer is generally not captured by the harvester and, instead, is cast rearwardly with MOG out the back of the harvester by the cleaning air flow. Thus, prior art chaffers are known to lose grain.

### OVERVIEW OF THE INVENTION

In one embodiment, the invention is directed to an adjustable chaffer assembly mounted in a chaffer housing of a combine harvester. The adjustable chaffer assembly includes a forward chaffer section and an aft chaffer section. The forward chaffer section has a forward frame assembly and adjustable forward louvers shiftably mounted on the forward frame assembly. The aft chaffer section has an aft frame assembly and adjustable aft louvers shiftably mounted on the aft frame assembly. The aft chaffer section is shiftably mounted relative to the forward chaffer section and is shiftable between a parallel condition where the forward and aft frame assemblies are substantially parallel with each other and an oblique condition where the forward and aft frame assemblies define an oblique angle.

In another embodiment, the invention is directed to an adjustable chaffer assembly mounted in a chaffer housing of a combine harvester. The adjustable chaffer assembly includes a forward chaffer section and an aft chaffer section. The forward chaffer section has a forward frame assembly and adjustable forward louvers shiftably mounted on the forward frame assembly. The aft chaffer section has an aft frame assembly and adjustable aft louvers shiftably mounted on the aft frame assembly. The aft chaffer section is shiftably mounted relative to the forward chaffer section. The adjustable chaffer assembly also includes an adjustment device configured to adjustably engage the aft chaffer section and is operable to locate the aft chaffer section relative to the chaffer housing among a plurality of aft chaffer section positions.

These and other features and advantages of this invention are described in, or are apparent from, the following detailed description of various example embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a left side schematic elevation of a chaffer assembly constructed in accordance with a first embodiment of the present invention, showing the chaffer assembly as being depicted as part of a harvester, with the harvester including, among other things, a threshing and separating rotor assembly, a precleaner, a fan, and a cleaning shoe, with the cleaning shoe including the chaffer assembly and a sieve;

FIG. 2 is rear perspective of the chaffer assembly and precleaner shown in FIG. 1, showing a chaffer housing, forward chaffer section, aft chaffer section, and a chaffer adjustment device of the chaffer assembly, with the aft chaffer section being secured in an uppermost position;

FIG. 3 is a fragmentary rear perspective of the chaffer assembly shown in FIGS. 1 and 2, with each of the forward and aft chaffer sections including a frame and a plurality of louvers that extend laterally and are spaced in series along a fore-and-aft direction, with the aft chaffer section being secured in a lowermost position;

FIG. 4 is an enlarged fragmentary rear perspective of the chaffer assembly shown in FIGS. 1-3, showing parts of the chaffer housing being removed to depict the pivotal joint between the forward and aft chaffer sections, where the forward chaffer section has end plates with tabs that pivotally receive pins of the aft chaffer section to provide the pivotal joint, and showing the aft chaffer section in the uppermost position;

FIG. 5 is a fragmentary cross section of the chaffer assembly shown in FIGS. 1-4, showing the louvers of the forward and aft chaffer sections in a closed position;

FIG. 6 is rear perspective of a precleaner and chaffer assembly constructed in accordance with a second embodiment of the present invention, showing a chaffer housing, forward chaffer section, aft chaffer section, and an alternative chaffer adjustment device of the chaffer assembly, with the aft chaffer section being secured in an uppermost position;

FIG. 7 is a fragmentary lower perspective of the chaffer assembly shown in FIG. 6, showing a lateral beam of the chaffer housing supporting a hydraulic cylinder of the chaffer adjustment device, with hydraulic cylinder being extended so that the aft chaffer section is in the uppermost position; and

FIG. 8 is a fragmentary upper perspective of the chaffer assembly shown in FIGS. 6 and 7, showing the hydraulic cylinder retracted so that the aft chaffer section is in the lowermost position.

Corresponding reference characters indicate corresponding parts throughout the views of the drawings.

### DESCRIPTION OF EXAMPLE EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

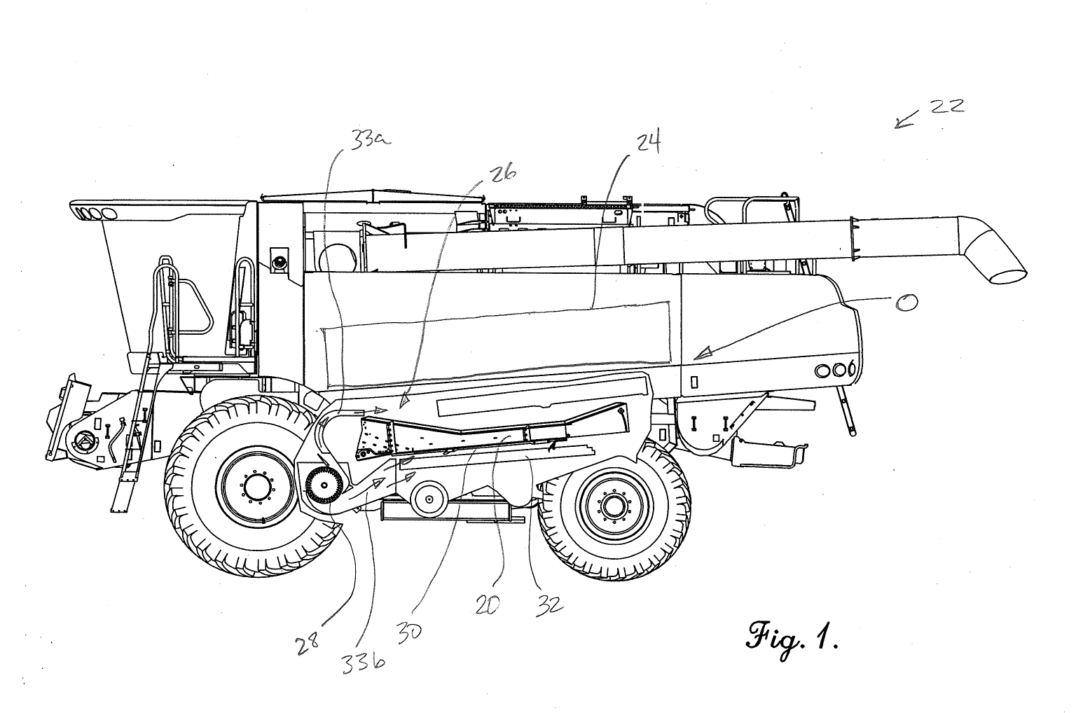

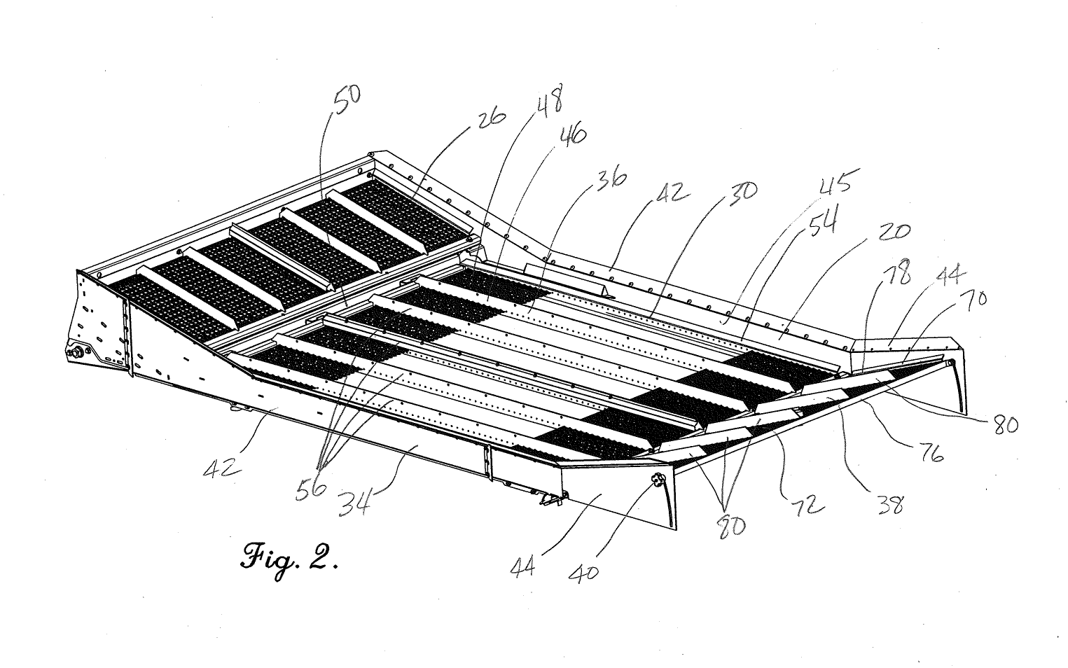

Turning initially to FIGS. 1 and 2, an adjustable chaffer assembly 20 is constructed in accordance with a preferred embodiment of the present invention and is depicted as part of a harvester 22. The illustrated harvester 22 includes, among other things, a threshing and separating rotor assembly 24, a precleaner 26, a fan 28, and a cleaning shoe 30. The cleaning shoe 30 preferably includes the chaffer assembly 20 and a sieve 32. However, it is also within the ambit of the present invention where the harvester 22 includes additional structure for use with the chaffer assembly 20 to thresh the cut crop material and separate grain from MOG.

In the usual manner, cut crop material is fed into the rotor assembly 24, with grain and material other than grain (MOG) being separated as material passes through the rotor assembly 24, rearwardly along the precleaner 26, and rearwardly through the cleaning shoe 30. Fan 28 urges air flow through upper and lower passages 33a, 33b, with air from the upper passage 33a exiting in a rearward direction above the cleaning shoe 30 and air from the lower passage 33b exiting in a rearward direction below the cleaning shoe 30. Some of the cut crop material does not pass downwardly through chaffer assembly 20, but instead passes rearwardly through a rear opening O defined between an aft margin of the chaffer assembly 20 and the rotor assembly 24. As will be discussed, the chaffer assembly 20 is adjustable to control the flow of cut crop material rearwardly through the rear opening O. The chaffer assembly 20 broadly includes a chaffer housing 34, forward and aft chaffer sections 36, 38, and a chaffer adjustment device 40. As will be discussed, the aft chaffer section 38 is preferably shiftable relative to the forward chaffer section 36.

Turning to FIGS. 1-5, the chaffer housing 34 adjustably supports the chaffer sections 36, 38 during operation of the cleaning shoe 30. The chaffer housing 34 includes chaffer panels 42 and rear panel extensions 44 that cooperatively define a trough 45 therebetween. The chaffer panels 42 and rear panel extensions 44 are each preferably formed from sheet metal and are removably attached to the chassis of harvester 22.

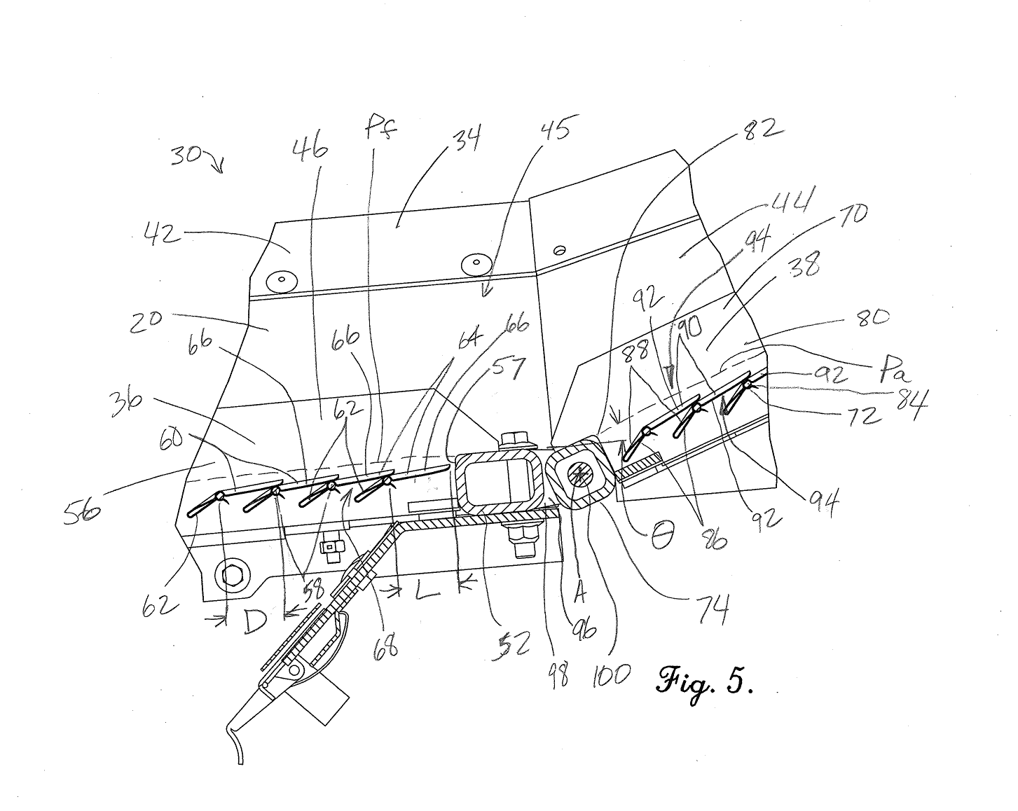

The forward chaffer section 36 is removably mounted on the chaffer housing 34 to operate as a sieve. The forward chaffer section 36 preferably includes a frame 46 and a plurality of louvers 48 mounted on the frame 46. The frame 46 preferably includes forward and aft tubes 50, 52, longitudinally extending side channels 54, and longitudinal dividers 56 fixed to the tubes 50, 52. The illustrated frame 46 preferably comprises a unitary structure and presents a forward chaffer exit opening 57 that preferably defines a forward plane Pf (see FIG. 5). This planar shape of the forward chaffer section 36 is only a general characterization of the preferred chaffer arrangement. It will be appreciated that the inventive chaffer assembly 20 could have a forward chaffer section 36 that presents an alternative shape, such as a curved shape, without departing from the scope of the present invention.

The louvers 48 are conventional and each includes a rod 58 and an elongated slat 60 fixed to the rod 58. The slat 60 preferably includes a forward vane section 62 that extends forwardly from the rod 58 and an aft sieve section 64 that extends rearwardly from the rod 58. The aft sieve section 64 preferably presents a plurality of fingers 66 spaced in series along the length of the slat 60, with each pair of adjacent fingers 66 defining an opening 68 therebetween.

The illustrated rods 58 are each rotatably mounted on the frame 46 so that each of the louvers 48 can pivot relative to the frame 46 about the corresponding rod axis. Preferably, the louvers 48 are spaced in the fore-and-aft direction so that each pair of adjacent louvers 48 define the same louver spacing dimension D. Also, the louver spacing dimension D is preferably less than a length dimension L of the fingers 66 so that the fingers 66 can contact an aft adjacent one of the louvers 48 when the louvers 48 are in a closed position (see FIG. 5). However, it is also within the ambit of the present invention where the louvers 48 are alternatively sized and spaced relative to one another. The illustrated louvers 48 are also preferably operably interconnected so as to pivot in synchronization with one another.

The aft chaffer section 38 is removably and adjustably supported by the chaffer housing 34 to operate as a sieve. The aft chaffer section 38 is preferably operable to be pivotally shifted relative to the forward chaffer section 36. It has been found that this structure allows the chaffer assembly 20 to control the amount of cut crop material that flows through the rear opening O. Furthermore, the illustrated chaffer assembly 20 can be adjusted to minimize the amount of grain that flows through the rear opening O while allowing MOG to pass rearwardly through the rear opening O.

The aft chaffer section 38 preferably includes a frame 70 and a plurality of louvers 72 mounted on the frame 70. The frame 70 preferably includes a forward frame section 74, an aft frame section 76, longitudinally extending side channels 78, and longitudinal dividers 80 fixed to the frame sections 74, 76. The illustrated frame 70 preferably comprises a unitary structure and presents an aft chaffer exit opening 82 that defines an aft plane Pa (see FIG. 5). Similar to forward chaffer section 36, the planar shape of the aft chaffer section 38 is only a general characterization of the preferred chaffer arrangement. It will be appreciated that the aft chaffer section 36 could present an alternative shape, such as a curved shape.

The louvers 72 are also conventional and each preferably includes a rod 84 and an elongated slat 86 fixed to the rod 84. The slat 86 preferably includes a forward vane section 88 that extends forwardly from the rod 84 and an aft sieve section 90 that extends rearwardly from the rod 84. The aft sieve section 90 preferably presents a plurality of fingers 92 spaced in series along the length of the slat 86, with each pair of adjacent fingers 92 defining an opening 94 therebetween. The illustrated rods 84 are each rotatably mounted on the frame 70 so that each of the louvers 72 can pivot relative to the frame 70 about the corresponding rod axis. Furthermore, the louvers 72 are preferably operably interconnected so as to pivot in synchronization with one another. While the louvers 72 can pivot independently of the louvers 48, it is within the scope of the present invention where louvers 48 and louvers 72 are operably interconnected to pivot in synchronization with one another.

Preferably, the illustrated louvers 72 are similarly sized and constructed to louvers 48. The louvers 72 are also preferably spaced in the fore-and-aft direction so that each pair of adjacent louvers 72 define the same louver spacing dimension D, with each louver 72 preferably having the same finger length dimension L as louvers 48. However, for some aspects of the present invention, the louvers 72 may be sized and spaced differently than louvers 48.

Again, the louver spacing dimension D is preferably less than the length dimension L of the fingers 92 so that the fingers 92 can contact an aft adjacent one of the louvers 72 when the louvers 72 are in the closed position (see FIG. 5). However, it is also within the ambit of the present invention where the louvers 72 are alternatively sized and spaced relative to one another.

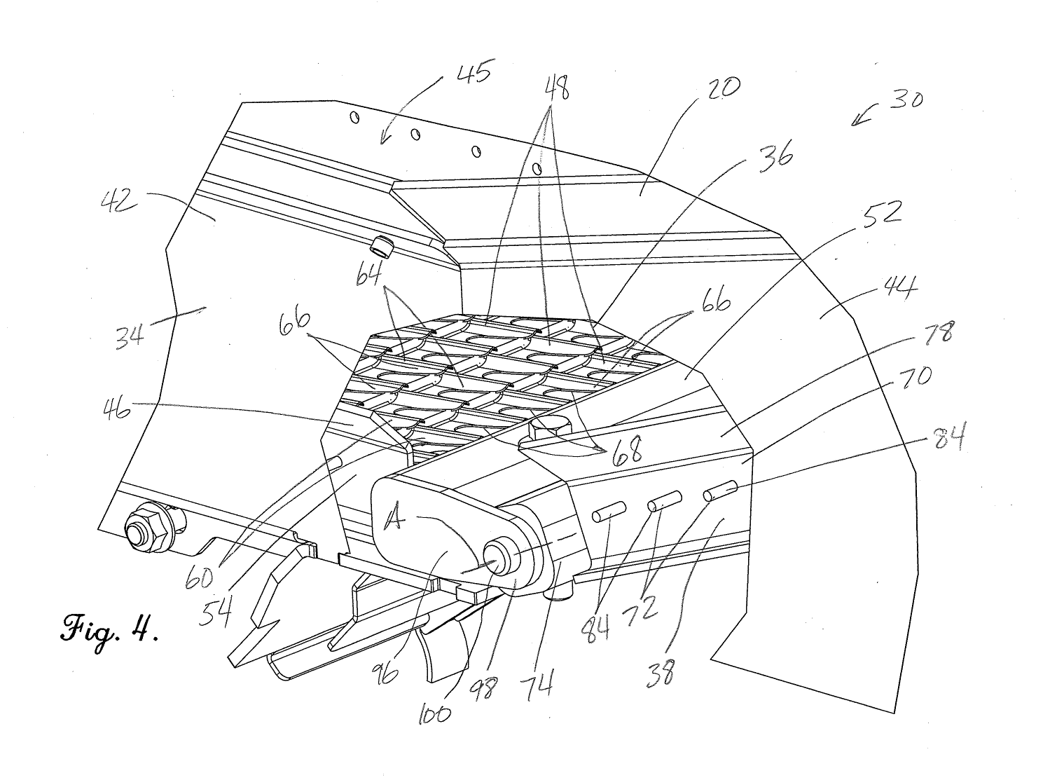

The aft chaffer section 38 is preferably pivotally mounted to the forward chaffer section 36. In particular, the aft tube 52 of the forward chaffer section 36 includes a tubular body and end plates 96 with tabs 98 that project rearwardly from the tubular body and present openings (see FIGS. 4 and 5). The aft chaffer section 38 is attached to the tabs 98 with pins 100 that extend through the openings and are secured to the forward frame section 74 to form a pivot joint between the forward and aft chaffer sections 36, 38. Thus, the aft chaffer section 38 is preferably pivotal relative to the forward chaffer section 36 and the chaffer housing 34 about lateral pivot axis A. However, it is within the scope of the present invention where the pivot joint between the chaffer sections 36, 38 is alternatively configured to provide relative pivotal movement between the chaffer sections 36, 38. Also, while the chaffer sections 36, 38 are preferably pivotally interconnected with each other, it is within the ambit of the present invention where the chaffer sections 36, 38 are alternatively connected relative to each other, e.g., where the chaffer sections 36, 38 are slidably mounted relative to one another, or not directly connected to one another.

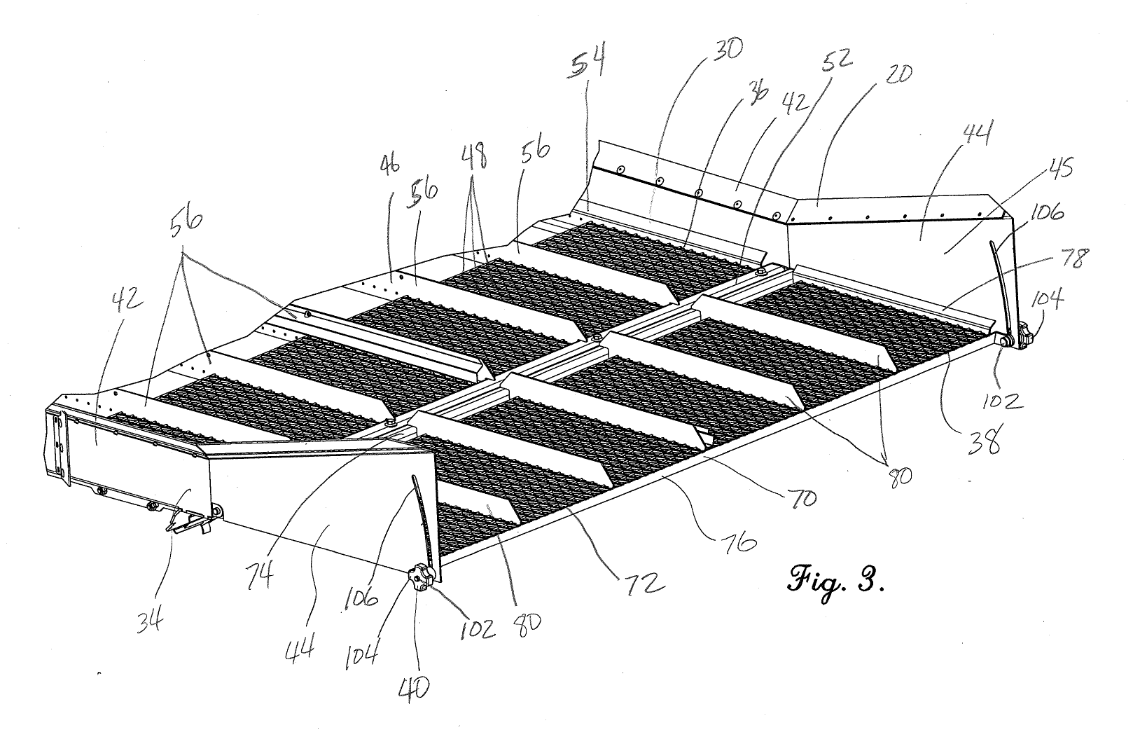

In the illustrated embodiment, the aft chaffer section 38 is preferably pivotal between a lowermost position (see FIG. 3) and an uppermost position (see FIG. 2). In other words, the chaffer construction preferably provides a range of tilt angles for the aft chaffer section 38. In pivoting between the positions, the aft chaffer section 38 is adjustable to control the flow of cut crop material rearwardly through the rear opening O. In particular, adjustment of the aft chaffer section 38 preferably changes the relative angular relationship between the forward and aft chaffer sections 36, 38. Furthermore, such adjustment also preferably changes the size of the rear opening O.

The chaffer adjustment device 40 is preferably operable to secure the aft chaffer section 38 in one of a plurality of positions relative to the chaffer housing 34. Preferably, the chaffer adjustment device 40 includes a pair of threaded bolts 102 secured to opposite ends of the aft frame section 76 and a pair of threaded nuts 104 removably threaded onto the bolts 102 (see FIG. 3). The bolts 102 extend laterally outwardly from the area of the trough 45, through curved slots 106 presented by respective rear panel extensions 44, and project laterally outwardly from the rear panel extensions 44. It will be appreciated that fasteners alternative to bolts 102 and nuts 104 could be employed to provide selective and adjustable securement of the aft chaffer section 38 without departing from the scope of the present invention.

The bolts 102 and slots 106 cooperatively restrict pivotal movement of the aft chaffer section 38 to a range of positions associated with the path of the slots 106. Again, in the illustrated embodiment, the aft chaffer section 38 is shiftable between the lowermost position (see FIG. 3) and the uppermost position (see FIG. 2) to provide a range of tilt angles for the aft chaffer section 38. While the illustrated adjustment device 40 is a preferred manual adjustment mechanism for the aft chaffer section 38, it is within the ambit of the present invention to provide an alternative manual adjustment to selectively and adjustably secure the aft chaffer section 38.

In the illustrated embodiment, the forward and aft planes Pf, Pa cooperatively define a tilt angle dimension θ (see FIG. 5). In the lowermost position, the tilt angle dimension θ preferably ranges from about negative ten (−10) degrees to about positive ten (10) degrees. More preferably, the tilt angle dimension θ in the lowermost position is about zero (0) degrees so that the planes Pf, Pa are substantially parallel to one another (see FIG. 3).

In the uppermost position, the tilt angle dimension θ preferably ranges from about fifteen (15) degrees to about forty-five (45) degrees and, more preferably, is about thirty (30) degrees (see FIG. 5). Thus, in the uppermost position, the planes Pf, Pa are preferably in an oblique condition where the planes Pf, Pa cooperatively define an oblique angle therebetween.

For any of the range of aft chaffer positions from the lower position to the uppermost position, the nuts 104 are threaded onto the bolts 102 to selectively secure the aft chaffer section 38 relative to the chaffer housing 34. While the illustrated chaffer adjustment device 40 is manually operated, as will be shown in a subsequent embodiment, the adjustment mechanism can also comprise a powered adjustment device.

In operation, the aft chaffer section 38 is selectively positioned to provide suitable separation of grain and MOG while restricting grain from being passed with MOG through the rear opening O. For instance, if the operator finds that grain has escaped through the rear opening O onto the ground during harvester operation, the operator can loosen nuts 104 to increase the tilt angle dimension θ of the aft chaffer section 38. The operator can then retighten the nuts 104 so that the aft chaffer section 38 is securely positioned.

Similarly, the operator can loosen nuts 104 to decrease the tilt angle dimension θ of the aft chaffer section 38, e.g., to permit increased flow of MOG through the rear opening O. The operator can then retighten the nuts 104 to secure the aft chaffer section 38.

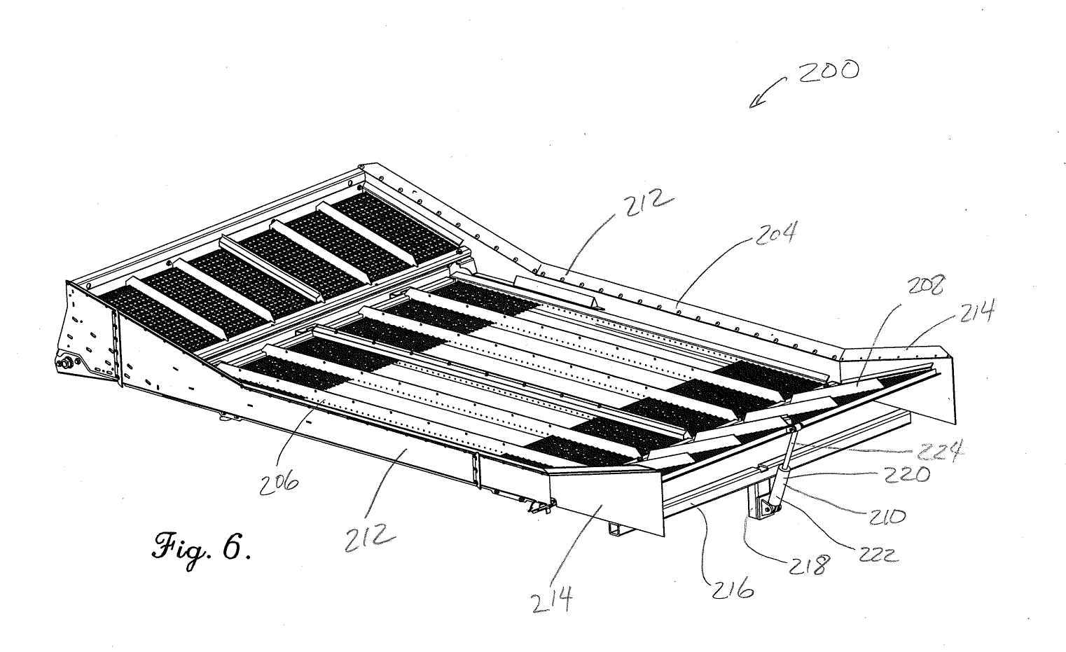

Turning to FIGS. 6-8, an alternative chaffer assembly 200 is constructed in accordance with a second preferred embodiment of the present invention. For the sake of brevity, the remaining description will focus primarily on the differences of this embodiment from the previously described embodiment. The alternative chaffer assembly 200 broadly includes an alternative chaffer housing 204, forward and aft chaffer sections 206,208 and an alternative chaffer adjustment device 210.

The alternative chaffer housing 204 preferably includes chaffer panels 212, rear panel extensions 214, a lateral beam 216 that interconnects the rear panel extensions 214, and a tubular post 218. The illustrated lateral beam 216 is tubular and is fixed to the post 218, with the post 218 being centrally located relative to the ends of the lateral beam 216 and projecting downwardly from the lateral beam 216. The ends of the lateral beam 216 are preferably mounted to the rear panel extensions 214.

The alternative chaffer adjustment device 210 preferably includes a hydraulic cylinder 220 with a cylinder body 222 and a piston 224. The cylinder body 222 presents a coupling end 225 that is removably attached to a mounting block 226 of the lateral beam 216. The mounting block 226 includes tabs 228, with the coupling end 225 being removably and pivotally attached to the tabs 228 with a pin 230.

The piston presents a coupling end 232 that is removably attached to the aft chaffer section 208. The aft chaffer section 208 includes a frame 234 with tabs 236. The coupling end 232 is removably and pivotally attached to the tabs 236 with a pin 238.

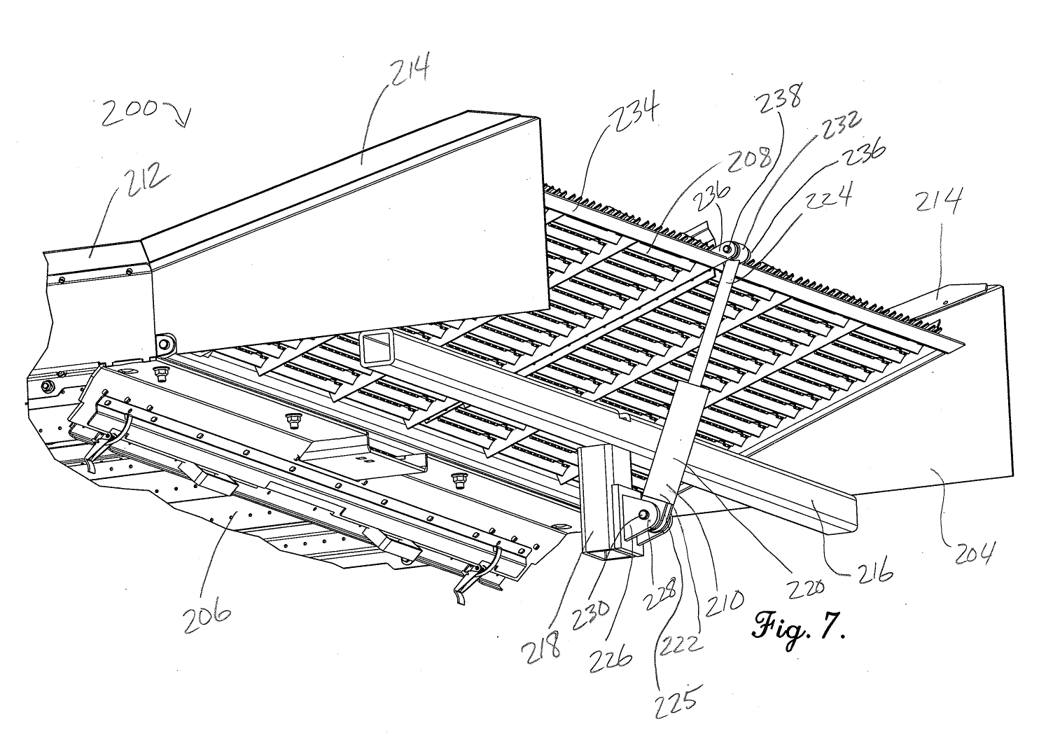

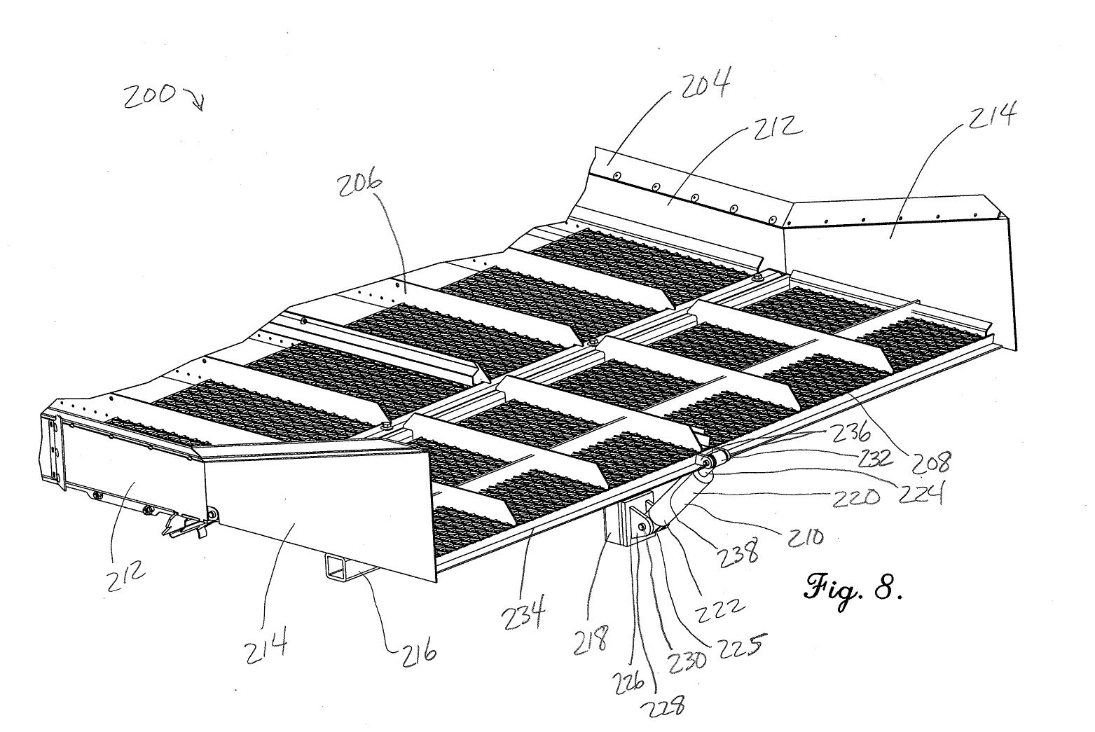

In the usual manner, the hydraulic cylinder 220 is shiftable between a retracted position, where the piston 224 is retracted within the cylinder body 222 (see FIG. 8), and an extended position, where the piston 224 is extended from the cylinder body 222 (see FIG. 7). In the illustrated embodiment, the retracted position is preferably associated with the aft chaffer section 208 in the lowermost position (see FIG. 8). The extended position is preferably associated with the aft chaffer section 208 in the uppermost position (see FIG. 7).

The alternative chaffer adjustment device 210 is preferably fluidly connected to a hydraulic power system (not shown) with a control valve (not shown) that can be moved by an operator to control hydraulic fluid flow to and from the hydraulic cylinder 220. Thus, the operator can remotely raise and lower the position of the aft chaffer section 208. It will be appreciated that the chaffer adjustment device 210 could include an alternative powered drive mechanism (e.g., an electronic solenoid, pneumatic cylinder, etc.) to shift the aft chaffer section 208 without departing from the scope of the present invention.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

1. An adjustable chaffer assembly mounted in a chaffer housing of a combine harvester, the adjustable chaffer assembly comprising:
a forward chaffer section, the forward chaffer section having a forward frame assembly and adjustable forward louvers shiftably mounted on the forward frame assembly; and
an aft chaffer section, the aft chaffer section having an aft frame assembly and adjustable aft louvers shiftably mounted on the aft frame assembly, wherein the aft chaffer section is shiftably mounted relative to the forward chaffer section and is shiftable between a parallel condition where the forward and aft frame assemblies are substantially parallel with each other and an oblique condition where the forward and aft frame assemblies define an oblique angle.

2. The adjustable chaffer assembly of claim 1 wherein the aft chaffer section is pivotal relative to the forward chaffer section and the chaffer housing about a lateral pivot axis

3. The adjustable chaffer assembly of claim 1 further comprising a chaffer adjustment device to shift the aft chaffer section relative the forward chaffer section.

4. The adjustable chaffer assembly of claim 3 wherein the chaffer adjustment device includes a pair of threaded bolts secured to opposite ends of the aft frame section and extending laterally outwardly through curved slots in the chaffer housing, wherein the bolts and slots cooperatively restrict pivotal movement of the aft chaffer section to a range of positions associated with the path of the slots.

5. The adjustable chaffer assembly of claim 1 wherein the forward frame assembly defines a forward plane and the aft plane assembly defines an aft plane, and the aft plane assembly is shiftable to a lowermost position in which a tilt angle between the forward plane and the aft plane ranges from about negative ten (−10) degrees to about positive ten (10) degrees, and the aft plane assembly is shiftable to an uppermost position in which the tilt angle ranges from about fifteen (15) degrees to about forty-five (45) degrees.

6. The adjustable chaffer assembly of claim 5 wherein the tilt angle in the lowermost position is about zero (0) degrees so that the forward and aft planes are substantially parallel to one another.

7. The adjustable chaffer assembly of claim 5 wherein the tilt angle in the uppermost position is about thirty (30) degrees.

8. The adjustable chaffer assembly of claim 3 wherein the chaffer adjustment device includes a hydraulic cylinder with a cylinder body and a piston movable between a retracted position and an extended position, the cylinder body presenting a coupling end that is removably attached to the chaffer housing and the piston presenting a coupling end that is removably attached to the aft chaffer section, wherein the retracted position is associated with the aft chaffer section in the lowermost position and the extended position is associated with the aft chaffer section in the uppermost position.

9. An adjustable chaffer assembly mounted in a chaffer housing of a combine harvester, the adjustable chaffer assembly comprising:
a forward chaffer section, the forward chaffer section having a forward frame assembly and adjustable forward louvers shiftably mounted on the forward frame assembly; and
an aft chaffer section, the aft chaffer section having an aft frame assembly and adjustable aft louvers shiftably mounted on the aft frame assembly, wherein the aft chaffer section is shiftably mounted relative to the forward chaffer section; and
an adjustment device configured to adjustably engage the aft chaffer section and is operable to locate the aft chaffer section relative to the chaffer housing among a plurality of aft chaffer section positions.
